(19) United States
(12) Patent Application Publication
(10) Pub. No.: US 2004/0243490 A1
(43) Pub. Date: Dec. 2, 2004

(54) Method and system for performing a financial transaction in a mobile communications system

(76) Inventors: Juhani Murto, Helsinki (FI); Mikko Juhani Olkkonen, Kirkkonummi (FI)

Correspondence Address: BANNER & WITCOFF, 1001 G STREET N W, SUITE 1100, WASHINGTON, DC, 20001, US

(21) Appl. No.: 10/487,356

(22) PCT Filed: Sep. 3, 2001
(86) PCT No.: PCT/FI01/00760

(51) Int. Cl. G06F 17/60

(52) U.S. Cl. 705/30; 705/39; 705/40

(57) ABSTRACT

The present invention generally relates to a method and system for performing a financial transaction in a mobile communications system. To enable diversified financial transactions between the originator and the recipient of the transaction, a first transaction message is sent to a transaction server and then processed. In response to said processing, a second and a third transaction message are generated. The second transaction message includes information required for performing the transaction in respect of thc first mobile network subscriber, and thc third transaction message includes information required for performing the transaction in respect of the recipient of the transaction. Said second transaction message is sent to a first mobile network billing centre for settling the transaction with respect to said first mobile network subscriber, and said third transaction message is sent to a system receiving the transaction for settling the transaction with respect to said recipient.

### FIELD OF THE INVENTION

The present invention generally relates to a method and system for performing a financial transaction in a mobile communications system.

### BACKGROUND OF THE INVENTION

Recently the need for performing transactions using a mobile phone has become more urgent, as the mobile phone penetration has exploded. An ordinary phone is developing towards a mobile wallet.

There are several alternative solutions for paying by a mobile phone on the market. A typical example is a vending machine which has a 0700-series number; the subscriber using the vending machine needs to call the 0700-number in order to make the vending machine operate, e.g. to deliver a fresh drink for the subscriber. Other daily examples of machines receiving payments through mobile phones are carwash machines or parking automates: In these applications, the party receiving the transaction has been registered into a payment system. In some solutions the mobile handset of the user needs to be reprogrammed, but in some solutions it is enough to send a text message to a predetermined number for paying for the service.

Some other solutions require a short message to be sent. Methods known in the art are described in international patent applications WO 00/18106 and WO 00/33264. These two publications deal with the task of charging and recharging a prepaid network account.

In WO 00/18106, call time is purchased in individually coded coupons. The subscriber willing to recharge his/her account will send a short message to a service number. A server analyses the message, and recharges the account on the basis of the subscriber identity contained in the sender Mobile Subscriber Identity Number (MSISDN).

In WO 00/33264 accounts are charged or recharged in a prepaid system. The user sends an unstructured supplementary service data message, which contains the amount to be charged/recharged, the user's secret code, and, optionally, a second subscriber ID. With the help of the latter the amount can be recharged to the prepaid account of the second user.

As the vending machine example above shows, it is not possible for the subscriber to freely choose the recipient of the transaction. In the other cited examples, the transaction has to be performed with coupons, or, the operation is limited to a prepaid environment, including subscribers with prepaid accounts only. It can easily be seen that customer satisfaction may decrease, as the systems are not very flexible, and cannot take post-paid subscribers.

An operator usually bills its users for using services, mostly in the form of a phone bill. A user can subscribe to e.g. a caller group icon or a ringing tone by sending a short message to a service number, the message indicating the desired icon or ringing tone. It has been possible to order icons or ringing tones to other subscribers as well by inserting the recipient MSISDN in the message. The subscriber making the order will be billed and usually no extra charge will be applied to the recipient. In these examples the charging is based on normal GSM charging, i.e. the delivery of the logo or ringing tone which forms the service will trigger a process creating a charging ticket, which will then be transformed to a GSM billing data base, either in the form of a charging detail record or a separate billing item.

In the example above, the user is limited by the selection of services available. He/she cannot make a transaction using a common currency, or other similar means.

Enabling flexible transactions in an ordinary GSM system is evidently a greater challenge, if the system also includes post-paid subscribers willing to perform many different kinds of transactions with other users of the same operator, with users of different operators, and with other transaction partners employing a variety of different systems. In fact, it has not been technically possible using a PLMN operator infrastructure.

The purpose of the invention is to address the problems described above. This is achieved by a method, a system and a transaction server described in the corresponding claims 1 and 11, respectively.

### SUMMARY OF THE INVENTION

The present invention relates to a method and system for providing a new service for the existing mobile network infrastructure. The objective of the invention is to enable diversified financial transactions between subscribers of one operator, between subscribers of two operators, and between a subscriber of a PLMN operator and an external party.

An additional advantage of secure transactions can be guaranteed. The security can be obtained using reliable subscriber authentication or by setting a threshold value for the transactions allowed.

A further benefit is that the subscriber is enabled to control the financial transactions, which are to be performed on his/her account. This can be achieved by enabling/disabling different parts of the service, and by setting fiscal or amount limits dependent on the recipient or type of transaction. Transactions can be classified in two formats, mobile originated and mobile terminated transactions. The transactions within a single PLM network, or between users of two compatible PLM networks, will be in both formats, the formats being different for the originator and the recipient.

Each transaction is started by a party willing to make the transaction. This is done by sending a message to the PLM network, the message indicating the recipient of the transaction and the size of the transaction.

Each financial transaction is related to at least one PLMN subscriber's account. The transaction size can be a twofold number, because the charged transaction amount may differ from the received transaction amount, if the operator(s) in question charge a commission for the transaction. For a single transaction, the charged transaction amount is the sum that will be charged to the account of the sending party. The received transaction amount is the sum that will be recharged to the recipient's account. Recharging here refers to putting a sum of money in the account. The charging or recharging of the PLMN subscriber's account is done by sending a Charging Detail Record (CDR) to the relevant billing centre of the PLMN network.

Besides being another mobile user, the opposite party may be an individual or an organisation having a bank account or a creditable credit card account, for example.

### BRIEF DESCRIPTION OF THE DRAWINGS

The invention is described more closely with reference to the examples in the accompanying drawings, in which

FIG. 1 illustrates a prior art PLM system, which has two PLM networks,

FIG. 2 illustrates a simplified PLM network architecture, which enables the performance of transactions between a subscriber and a second party,

FIG. 3 shows a possible message format for a user-originated command initiating the transaction,

FIG. 4 depicts a schematic signalling diagram of the transaction service in operation, and

FIG. 5 is an example of a record residing in the payment database.

### DETAILED DESCRIPTION OF THE INVENTION

In the PLMN charging, the operator usually collects data about all the events that can be used as a basis for the charging. These are known as charging events. Usually this phase is concerned with collecting the information about a call only. At this charging phase how much the subscriber will be charged is not yet calculated.

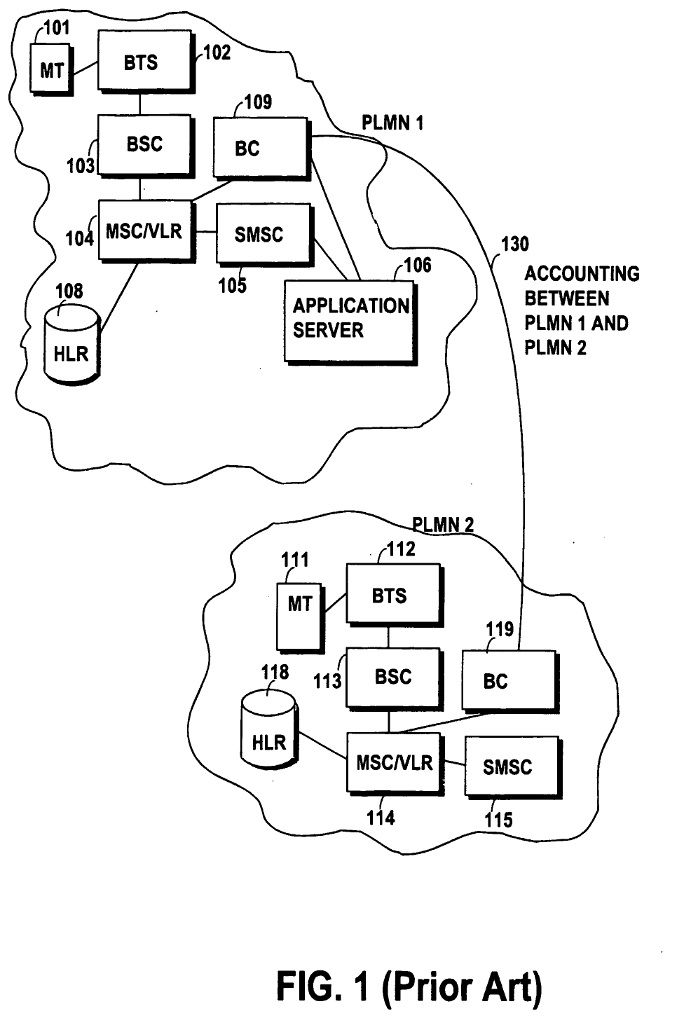

FIG. 1 depicts a prior art PLM network, which in this example is a GSM network. Usually a call, a short message or some other PLM service, is transmitted from a mobile terminal 101 via a Base Transceiver Station 102 and a Base Station Controller 103 to a Mobile Switching Centre (MSC) 104. The MSC takes care of routing calls to recipients, or messages to a Short Message Centre 105. The short message centre stores and forwards the messages to the recipients. In PLM networks the subscribers may be roaming in different networks, in which case the Home Location Register (HLR) 108 has information of the current MSC of the subscriber. More precisely, the networks have Visitor Location Registers (VLR), which are normally directly connected to the respective MSC. The VLR is the network element, which contains information about subscribed services, and possibly some means for performing subscriber authentication. The latter is usually performed in such a way that the VLR requests some test keys and signatures from the subscriber's home network authentication centre or HLR. The VLR then sends the keys to the subscriber terminal, and the terminal returns the signatures for the keys. If the latter signature matches with the signature retrieved from the HLR, the subscriber is probably a valid subscriber.

If the network is a packet switched network, the elements handling the circuit switched traffic usually are replaced with their packet-oriented counterparts. In this kind of network, the principles of operation do not differ significantly from those described above. For example, in the GPRS architecture the packet data elements are generally Supporting GPRS Support Node (SGSN) and Gateway GPRS Support Node (GGSN), the former perform the packet-related tasks of the MSC and the latter act as a gateway towards external networks.

Referring to FIG. 1, the network elements that take care of creating the charging data are the MSC 104, the HLR 108, and possibly some additional application server 106 residing in the network. An example of an application server can be found from e.g. WO 99/57662, in which there is an application program in the network, which specifies the cost for using each application program in terms of charging units. The application program has an interface between each application program and the transaction server. The application forwards cost information in terms of charging units.

The billing, on the other hand, includes the pricing and generating the bill for the subscriber. The cost of each call is calculated in the Billing Centre 109 based on the charging information received from the MSC 104, or some other network element producing the charging detail data, via data communication links.

As most PLMN networks are access networks, it is probable that two users, between which a communication or transaction is going to take place, are subscribers of different networks (PLMN 1 and PLMN 2 in FIG. 1). Most operators have agreed that they periodically compare the costs caused by the calls from one network to another and settle their accounts. The billing between operators is called accounting 130. Usually the accounting is transparent to the end-user, and is performed by exchanging summary information between the billing centres 109, 119 of the two operators.

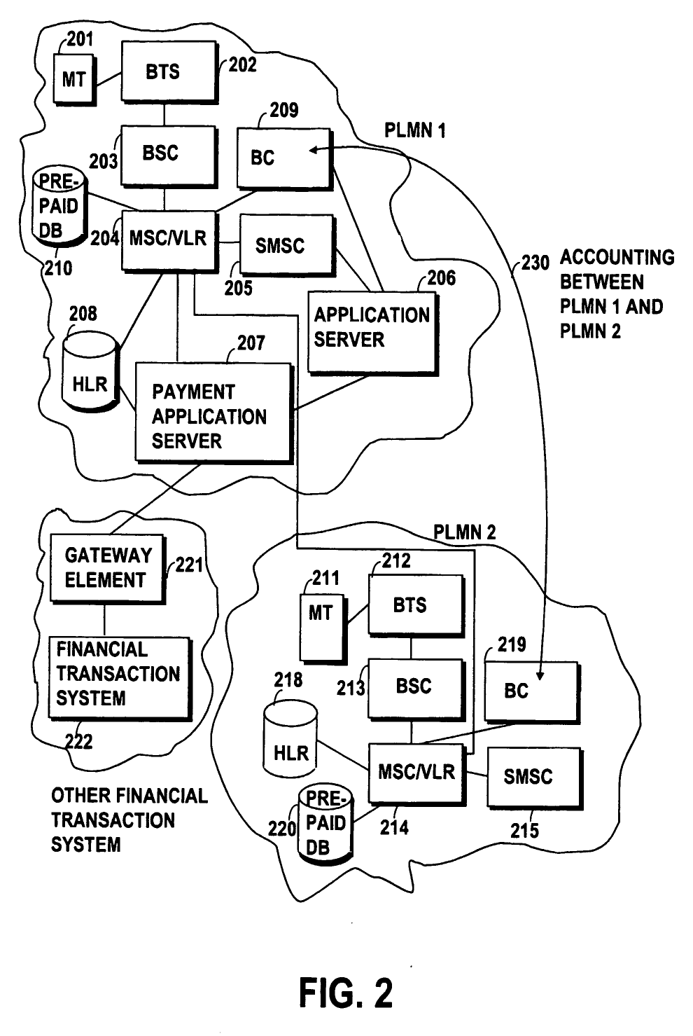

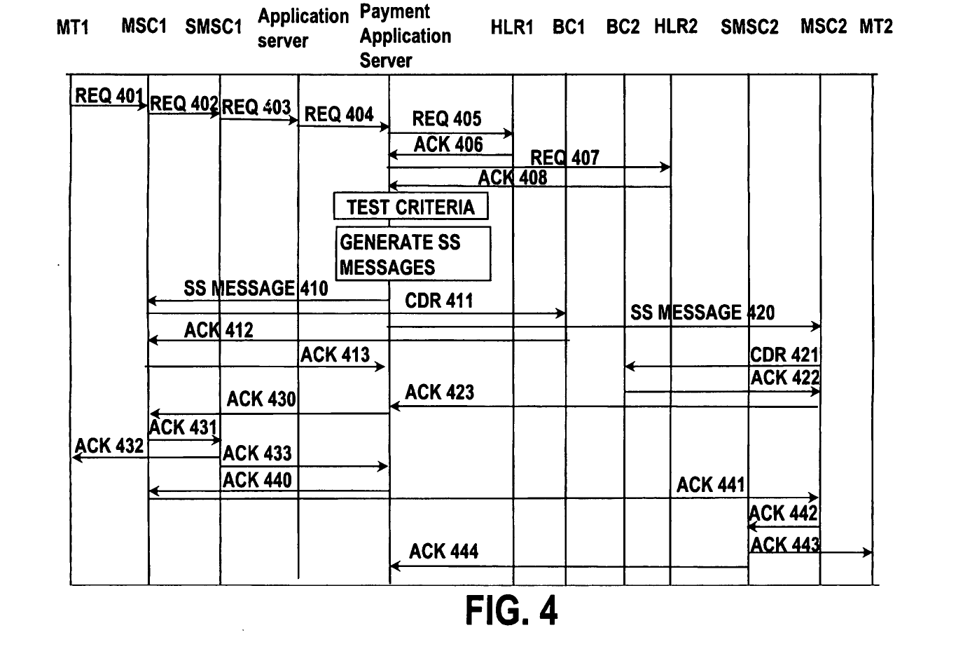

A schematic network architecture of the present invention is depicted in FIG. 2. The invention relates to a method and a system, in which a first PLMN subscriber 201 can easily make a financial transaction with a second PLMN subscriber 211. Not limited only to this, the first subscriber can also make a financial transaction with some other party, which is not a PLMN subscriber, but a client of some financial transaction system 222 or an external transaction system. Below, two preferred embodiments will be discussed with reference to FIGS. 2, 3 and 4.

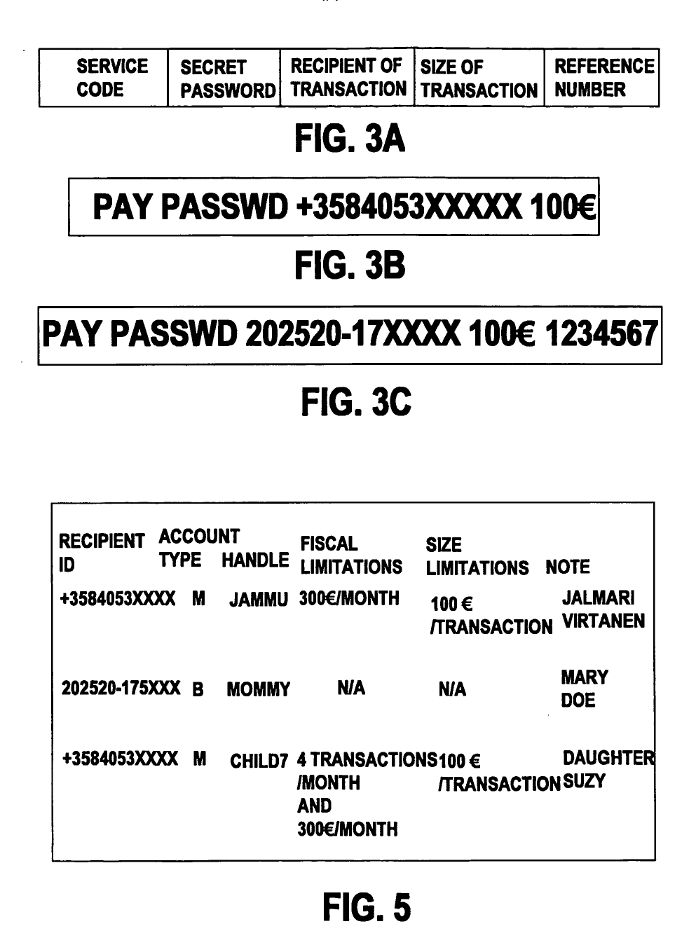

In the first embodiment, the first subscriber with MSISDN1 201 sends a short message 401 that is in the form of FIG. 3A, containing at least a service code, the recipient of the transaction, and the size of the transaction. The example message is (FIG. 3B) “PAY PASSWD MSISDN2 100 [symbol] ” addressing a network number 17000. The message is transmitted, as usual, via a BTS 202 and BSC 203 to an MSC 204, which forwards the SMS 402 to an SMSC 205. The SMSC forwards the message 403 to an application server 206 on the basis of the destination address 17000 in the secondary address part in the original message 403. The application server identifies the service code PAY in the message, and forwards the control 404 to a payment program block with four parameters MSISDN1, MSISDN2, 100 [symbol] , PASSWD. For the sake of clarity, the payment program block resides in a separate payment application server 207.

An application server distinct from the payment application server has been chosen, as in this way the subscriber does not have to remember many service numbers, but can use service commands that comply to normal ontology. The application server interprets at least part of the service command, the service interface language thus forming a sort of hierarchy for the user interface of the service, i.e. a front end of the service. The application server may extract the parameters from the message and further pass them to the correct application.

Another reason for selecting a distinct server is that the load in the application server increases for services possibly having to send requests to several networks. The application server may be involved with many other services, for which there has to be enough resources reserved in order to avoid harmful latency times for performing the services.

It is first observed in the payment program block that MSISDN1 is the originating party 201 for the financial transaction. It is assumed here that the home operator of the first subscriber utilizes a known method for preventing fraud, whereby it can be trusted that the subscriber with MSISDN1 is the true party willing to make a transaction. In the GSM system, for example, authentication triplets are used to ensure that the SIM card is original. In the coming UMTS system, authentication vectors, which guarantee enhanced security, are used. Also some ways to request a personal identification number (PIN) code from the subscriber are known in the art for authenticating the subscriber. In order to assure enhanced security in case of a stolen mobile, or some unauthorized user using the handset of a valid subscriber, a password can be attached in the original transaction request message 401.

However, it is not evident that the subscriber using MSISDN1 is legible to perform a financial transaction. This may be the case, for example, when the first subscriber is a minor, a pre-paid subscriber with limited credit, or if the subscription is for a company employee for whom the phone bill will be paid by the employer etc. In other words, there are many subscribers, for which the activation of the service is not allowed. The steps necessary for the activation of the new service are discussed below in more detail.

In order to avoid any trouble, a new service class with a new charging record type may be added to the HLR for the first operator. Table 1 lists some types of charging records already existing in the HLR.

TABLE 1
Examples of types of charging records

Mobile Originated or Terminated Call
Call to a Roaming Subscriber
Forwarded Call
Supplementary Service, use of supplementary service, activation
Location Update
HLR Interrogation
Mobile Originated or Terminated Short Messages
PSTN Originated or Terminated Call
PBX Originated or Terminated Call
Unstructured Supplementary Service Data
Intelligent Network Data

The charging records correspond to teleservices (Table 2) or supplementary services (Table 3). Teleservices are services, which define the data flow from terminal to terminal. The information sent in the network has a specified format and the network is able to interpret it in a proper way.

TABLE 2
Teleservices

T11 = Telephony
TD1 = Alternate line service
T21 = Short Message MT/PP
T22 = Short Message MO/PP
T61 = Facsimile Group 3 and alter speech
T62 = Automatic facsimile group 3

In addition to teleservices, a PLMN usually has some supplementary services (Table 3). They add new functionalities to a basic service. Some of the supplementary services are optional.

TABLE 3
Supplementary services

Advice of Charge
Call Hold
Calling Line ID Presentation
Calling Line ID Restriction
Call Transfer
Private Numbering Index
Redirection Destination Index
Multi Party Service
Intelligent Network Category Key
Service Set Index
Charging Class
Charging Area
Hot Billing
Call Restriction Services ( . . . )
Call Forwarding Services ( . . . )
Call Completion Services ( . . . )

The HLR network element 208 has information about services available to a subscriber, both as teleservices and as supplementary services. The HLR has, preferably, a specific record for each service (marked with dots in Table 3), but at least a field in a collection record (items with no dots in Table 3).

Thus, in order to offer a payment supplementary service in a PLMN, a supplementary service of this type has to be defined in the HLR. There are several options how the service can be implemented and restricted, but the first necessary step is to check whether the operation is permissible for a specific subscriber. In the HLR 208 the new payment supplementary service can be activated in MOBILE ORIGINATED or MOBILE TERMINATED modes. Naturally the MOBILE ORIGINATED mode also allows MOBILE TERMINATED financial transactions. If the MOBILE ORIGINATED payment would be literally restricted to mobile originated payments, of course a new type, which would allow transactions in both directions, could be defined.

As soon as the HLR 208 contains the information about the existing payment supplementary service, the payment application server 207 can send a request “MO PAY ALLOWED” 405 to the HLR. Alternatively, the visited VLR (which is connected to the MSC) usually retrieves service data from the HLR, and hence the request can be addressed to a VLR as well. However, in this example it is the HLR that has to be consulted in connection with the payment service, as the payment service is based on an agreement between a subscriber and his/her home operator. Of course the operators can negotiate service conditions between each other, but in this example the home operator bears the risk of bad debts caused by the user and it is always the home operator, which decides whether or not a transaction is to be allowed. The HLR can be contacted on the basis of MSISDN1, or, alternatively, from the IMSI of the first subscriber. Normally the SMSC 205 or payment application server 207 will not know the IMSI, but as the relationship between the MSISDN and the IMSI is known, this is another way to realize the method.

The payment application server 207 may attach a further parameter in the request defining the size of the financial transaction, or the recipient of the transaction, or some other relevant information, like the reference number of the payment which can be used for correlating payments and bills in common financial systems.

The HLR checks whether the requested payment service is allowed and, if some parameters are supplied, compares them with some predetermined criteria. If the result of analysis is that the service is allowed, the HLR sends an acknowledgement 406 to the payment application server 207. Otherwise the result will be a negative acknowledgement, which makes the payment application server stop the processing of the transaction.

The payment application server then queries the HLR of the receiving subscriber 218, whether the receiving subscriber 211 with the MSISDN2 has the MOBILE TERMINATED TRANSACTION supplementary service activated. This HLR enquiry 407 is in the form of a message “MT PAY ALLOWED”. In case of a positive result, an acknowledgement 408 is transmitted. Otherwise the reply will be a negative acknowledgement, having a similar effect to the negative acknowledgement discussed above.

If both acknowledgements are successful, the payment application server generates messages related to the supplementary service used. In other words, it generates a first message 410 to the first MSC 204 stating that the account of the first subscriber has to be charged, and second message 420 to the second MSC 214 stating that the account of the second subscriber has to be recharged.

The first MSC 204 then generates a charging detail record 411 and sends it to the billing centre 209 of the PLM network 1. The second MSC 214 also generates a charging detail record 421 and sends it to the billing centre 219 of the PLM network 2.

After receiving acknowledgements from the first MSC 413 and the second MSC 422, the payment application server may conclude that the transaction has been completed. It may then send a notification to the originator of the transaction 201, to the recipient of the transaction 211, or to both. The notifications can be in the form of short messages 430 and 440, which are first routed (431, 441 and 442) via the relevant MSCs to the relevant SMSCs 205 and 215 which take care of the storing and delivering of the notification messages 432 and 443. After completing the transmission of the notification messages, the SMSC 205 and 215 send acknowledgements stating the success of the delivery of the notification messages.

FIG. 5 presents a sample record for a payment application database. The recipient IDs can be mapped onto handles which act as shortcuts so that the originator of the transaction need not enter all information in the original request 401. If the system is connected to some other financial transaction system, there may also be an indicator for the account type. The types of the accounts can be e.g. mobile subscriber account, prepaid account, bank account, or a credit company account.

There can also be some restrictions for the transactions in the payment application database. The restrictions can be set to a single transaction, for a single recipient, or for cumulative transactions to one recipient, all recipients or all transactions, and there may be specific criteria for calculating the cumulative size of the transactions in a specific time interval. For convenience, the real name of the recipient can be added to the database.

If a second subscriber touches a first subscriber for money, the financial transaction would then be the first subscriber lending a certain amount to the second subscriber. The second subscriber can send the request via the transaction system, which has a log for requests. The first subscriber needs only to confirm the transaction by sending a transaction message to the transaction system. The system may further comprise a table for this kind of transaction, specifying the amount, the date of the transaction and possibly the agreed interest.

The easiest way for a subscriber to control the contents of the database is via a WWW interface. He/she can edit the contents using a standard browser. However, it has to be noted that the editing can be performed using a WAP browser if the database is accessible with a WML interface, or the database can be equipped with a standard query language interface in order to allow editing by some other means such as plain short messages in some predetermined format.

The user can submit his/her secret password to the database. The first time the service is activated the system can generate a pseudo random password and deliver it to the user, but most conveniently the user can select a suitable password for him/herself. The password file in the database can be a shadow password file, which will be decrypted in UNIX-style.

Alternatively, the SMSC can generate the payment CDR itself, provided that the transaction request includes the information needed for performing the operation in, or that the SMSC has an access, to the payment detail database described above.

If the subscriber is roaming in a different network, the CDR can be generated by the visited VLR or HLR as well. A prerequisite for this, just like in the case of an SMSC-enabled CDR production, is that the operators have agreed on the procedure in advance.

If the payment application is accessible for a mobile commerce application as well, the payment application creates a message in the desired format at least partially based on information received from the first subscriber, which message preferably is an SMS message, and either sends it to the subscriber in order that the subscriber adds his/her secret password and returns the message to the payment application, or sends at least a confirmation request to the subscriber. The subscriber can confirm the transaction by sending a secret code, a personal identification number or just by signing the message with his/her digital signature. The signature can be verified with the user's public key, to which the payment application can have access. Alternatively, the signature can be checked by an authentication centre, which will be available at least in UMTS networks, for example.

One option is to provide the mobile terminal with client software, containing the database described above, and then send messages in the correct format to the payment application.

The payment application server is preferably a normal server with a TCP/IP connection to other external financial account systems. The server can also have a TCP/IP connection to the application server 206. The path from the mobile terminal to the payment application server can utilize standard application interface protocols such as HTTP or WAP.

A MOBILE ORIGINATED charging ticket needs not to be a positive charging ticket, which would only increase the phone bill of the originating party, but the system can be reversed so that the payment service becomes a borrow/lend service. In this way the originating party would receive a financial transaction for which the recipient would be charged. In practice, this can be implemented using the same solution, but the recipient needs to confirm the transaction, which can be done utilizing the same confirmation message system, password or PIN algorithm described above.

It is to be understood that the architecture can also be implemented using Intelligent Network building units, in which case the interoperability between different operator networks can be obtained using a solution corresponding to the new CAMEL standard. Consequently, there would be an Intelligent Network Application (INAP) interface in the MSC and service control point (SCP). As the IN architecture is better suited for call-related services, the connectionless solution described above and utilizing point-to-point messages, such as short messages or data packets is preferable.

The examples discussed above relate to a GSM system. However, a method and system according to the invention can be realized not only in GSM or UMTS, but also in any communications system having similar network elements.

Because of the nature of the invention, the end result will not be dependent on the selected technology, but the invention can be implemented using many different technologies. Hence the invention will not to be limited by the detailed description but has to be interpreted in the spirit described in the independent and dependent claims.

1. A method for performing a transaction from a first mobile network subscriber to a recipient of the transaction, the method including the steps of
sending a first transaction message to a transaction server,
processing said first transaction message,
in response to said processing, generating a second and a third transaction message, said second transaction message including information required for performing the transaction in respect of the first mobile network subscriber, and the third transaction message including information required for performing the transaction in respect of the recipient of the transaction,
sending said second transaction message to a first mobile network billing centre for settling the transaction with respect to said first mobile network subscriber, and
sending said third transaction message to a system receiving the transaction for settling the transaction with respect to said recipient.

2. A method according to claim 1, further including the steps of
sending an enquiry to a mobile network subscriber database, the enquiry including an identifier identifying said first mobile network subscriber,
receiving a response from said database,
on the basis of the response, deciding whether the transaction is to be continued.

3. A method according to claim 1, further including the steps of
monitoring the transaction, and
in response to said monitoring, sending a notification to said first mobile network subscriber indicating the result of the transaction.

4. A method according to claim 1, further including the steps of
storing information about recipients of transactions in a database, and
generating a recipient identifier part for said third transaction message at said processing step using said stored information.

5. A method according to claim 1, wherein said recipient is a second mobile network subscriber and said third transaction message is sent to a mobile network billing centre.

6. A method according to claim 1, wherein the first transaction message is stored in a database.

7. A method according to claim 5, wherein said transaction involves the first mobile network subscriber lending money to the second mobile network subscriber.

8. A method according to claim 1, wherein said transaction involves the first mobile network subscriber recharging a prepaid phone account.

9. A method according to claim 1, wherein said transaction involves the first mobile network subscriber making a giro.

10. A method according to claim 1, wherein said first transaction message is a short message.

11. A system for performing a transaction from a first mobile network subscriber to a recipient of the transaction, the system comprising
first receiving means for receiving a first transaction message at a transaction server,
processing means for processing said transaction message,
first message generating means, responsive to said processing means, for generating a second transaction message, which includes information required for performing the transaction in respect of the first subscriber,
second message generating means, responsive to said processing means, for generating a third transaction message, which includes information required for performing the transaction in respect of the recipient of the transaction,
first sending means, for sending the second transaction message to a mobile network billing centre for settling the transaction with respect to said first mobile network subscriber,
second sending means, for sending the third transaction message to a system receiving transactions for settling the transaction with respect to said recipient.

12. A system according to claim 11, further comprising
third sending means, responsive to said first receiving means, for sending an enquiry to a mobile network subscriber database, the enquiry including an identifier identifying said first mobile network subscriber,
second receiving means, responsive to said third sending means, for receiving a response from said data base, and
selecting means, responsive to said second receiving means, for deciding whether the transaction is to be continued.

13. A system according to claim 11, further comprising
monitoring means for monitoring the transaction, and
third sending means, responsive to said monitoring means, for sending a notification to said first mobile network subscriber indicating the result of the transaction.

14. A system according to claim 11, further comprising
storing means for storing information about recipients of transactions, and
retrieving means, responsive to said storing means, for retrieving said information, and
generating means, responsive to said retrieving and processing means, for generating a recipient identifier for said third transaction message using said stored information.

15. A system according to claim 11, wherein said recipient is a second mobile network subscriber and said second sending means are adapted to send the third transaction message to a second mobile network billing centre.

16. A system according to claim 15, wherein said transaction involves the first mobile subscriber lending money to the second mobile subscriber.

17. A system according to claim 11, wherein said transaction involves the first mobile network subscriber recharging a prepaid phone account.

18. A system according to claim 11, wherein said transaction involves the first mobile network subscriber making a giro.

19. A system according to claim 11, wherein said first transaction message received by the first receiving means is a short message.
